(19) United States
(12) Patent Application Publication
(10) Pub. No.: US 2017/0111557 A1
(43) Pub. Date: Apr. 20, 2017

(54) CAMERA ASSEMBLY WITH FILTER PROVIDING DIFFERENT EFFECTIVE ENTRANCE PUPIL SIZES BASED ON LIGHT TYPE

(71) Applicant: Google Inc., Mountain View, CA (US)

(72) Inventors: Jamyuen KO, Mountain View, CA (US); Chung Chan WAN, Mountain View, CA (US)

(21) Appl. No.: 14/887,786

(22) Filed: Oct. 20, 2015

(51) Int. Cl. H04N 5/225; G02B 7/02; G02B 5/20

(52) U.S. Cl. CPC H04N 5/2254; G02B 5/208; G02B 7/02; H04N 5/2253

(57) ABSTRACT

A camera assembly includes a lens barrel assembly comprising at least one optical element arranged about an optical axis. The camera assembly further includes a filter substantially coaxial with the optical axis. The filter presenting a first aperture having a first width for transmission of infrared light and a second aperture having a second width for transmission of visible light, the second width less than the first width. The second aperture may be defined by a center region of the filter that is transparent to visible light and infrared light, and the first aperture may be defined by the center region and a perimeter region substantially surrounding the center region, the perimeter region transparent to infrared light and opaque to visible light.

### BACKGROUND

Field of the Disclosure

The present disclosure relates generally to image capture and, more particularly, to camera assemblies for image capture.

Description of the Related Art

Conventional camera assemblies used to capture visible light images (e.g., red-green-blue (RGB) images) typically are unsuited for infrared image capture as the imaging sensors used in such camera assemblies exhibit low spectral response in the infrared (IR) spectrum. One common approach to add IR imaging capability to an electronic device is to include a separate IR-light-specific camera assembly in addition to a visible-light-specific camera assembly. However, this approach requires two camera assemblies, and thus increases the cost, complexity, and size of the electronic device. Another approach is to utilize an imaging sensor with IR-light-sensitive pixels interspersed with the conventional visible-light-sensitive pixels. This provides somewhat improved performance over the use of a standard RGB imaging sensor, but the sensitivity of the IR-light-sensitive pixels remains relatively low compared to the visible-light-sensitive pixels. As such, an f-stop setting suitable for visible light capture would result in a captured IR image with unacceptably low contrast. Conversely, an f-stop setting suitable for IR light capture (that is, sufficiently large to provide increased IR illuminance) would result in increased aberrations, such as spherical, coma, and astigmatism aberrations, in a visible light image captured using the same f-stop setting.

Many conventional camera assemblies tasked for both visible light image capture and IR light image capture implement a single f-stop that is a disadvantageous compromise between a suitable f-stop for visible light capture and a suitable f-stop for IR light capture. In an attempt to avoid this compromise, some conventional camera assemblies utilize a mechanical shutter apparatus to either alter the entrance pupil diameter or alter the focal length, and thus alter the f-stop, between visible light image capture and IR light image capture, but this approach prevents the concurrent capture of visible light imagery and IR light imagery, as well as leading to increased cost and complexity due to the mechanical apparatus employed to alter the f-stop settings.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an exploded view of a camera assembly with a camera filter providing dual, co-planar entrance pupils in accordance with some embodiments.

FIG. 2 illustrates a perspective view of the camera assembly of FIG. 1 in accordance with some embodiments.

FIG. 3 illustrates a camera filter providing dual effective apertures in accordance with some embodiments.

FIG. 4 illustrates a cross-section view of the camera assembly of FIGS. 1 and 2 in accordance with some embodiments.

FIG. 5 illustrates a front view of an electronic device employing a camera assembly in accordance with some embodiments.

FIG. 6 illustrates a rear view of the electronic device of FIG. 5 in accordance with some embodiments.

### DETAILED DESCRIPTION

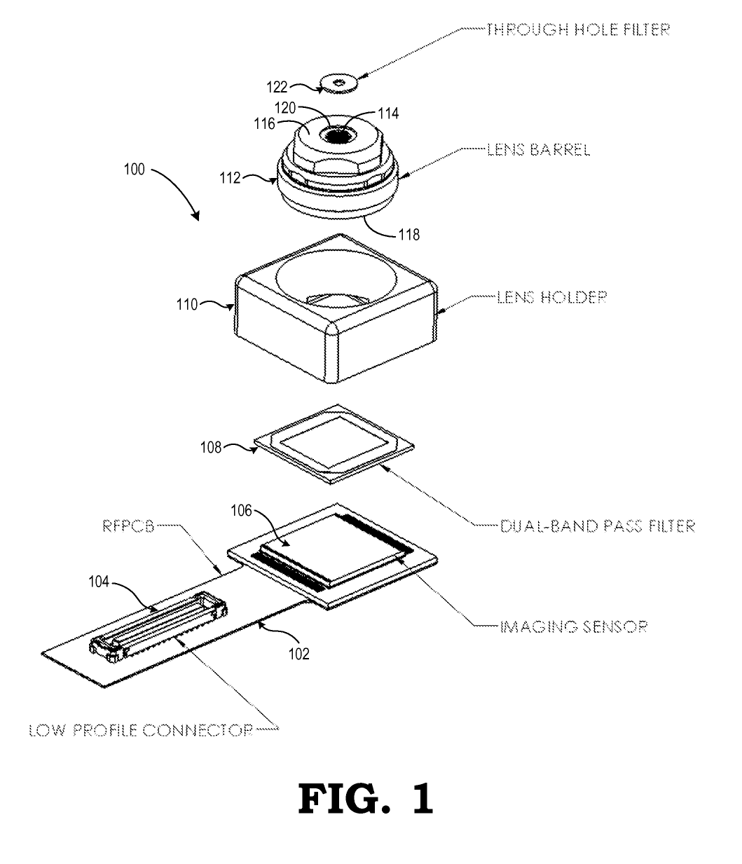

FIGS. 1-6 illustrate a camera assembly employing a filter that defines dual entrance pupils of two different effective widths, and thereby providing two different effective f-stops concurrently for visible light capture and IR light capture by an imaging sensor of the camera assembly. In at least one embodiment, the filter is arranged so as to be substantially coaxial with the optical axis of the camera assembly, such as at an entrance aperture of a lens barrel assembly or within the lens barrel assembly. The filter comprises a planar member having a center region and a perimeter region encircling or otherwise surrounding the center region. The center region is transparent to both visible light and infrared (IR) light, while the perimeter region is transparent to IR light and opaque to visible light. As a result, the entrance pupil for visible light capture by the imaging sensor is effectively defined by the width or diameter of the center region, whereas the entrance pupil for IR light capture is effectively defined by the width or diameter of the wider perimeter region. Accordingly, the filter provides two different concurrent f-stops, one for visible light and one for IR light, and thus permits the imaging sensor to concurrently capture visible light imagery using an f-stop setting suitable for visible light capture and a different f-stop setting suitable for IR light capture.

The term “visible light,” as used herein, refers to electromagnetic radiation having a wavelength between 390 and 700 nanometers (nm). The term “infrared (IR) light,” as used herein, refers to electromagnetic radiation having a wavelength between 700 nm and 1 millimeter (mm). The term “transparent”, as used herein, refers to a transmittance of at least 10% of the referenced electromagnetic radiation, whereas the term “opaque,” as used herein, refers to a transmittance of less than 10% of the referenced electromagnetic radiation. Thus, a material described as “transparent to IR light and opaque to visible light” would transmit at least 10% of IR light incident on the material and transmit less than 10% of visible light incident on the material.

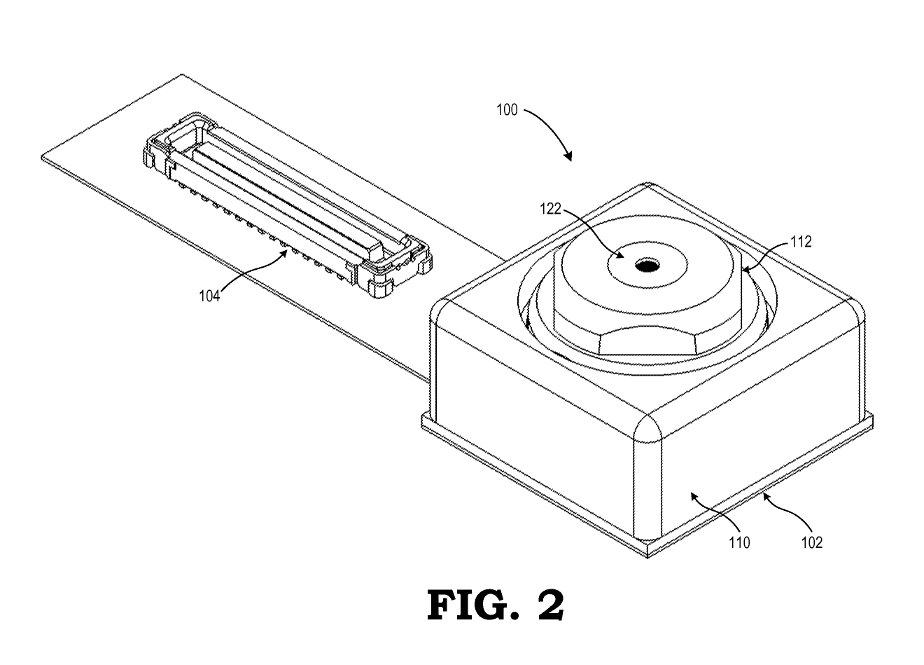

FIGS. 1 and 2 illustrate an exploded view and a perspective view, respectively, of a camera assembly 100 that concurrently provides different effective f-stops for visible light and IR light in accordance with at least one embodiment of the present disclosure. In the depicted example, the camera assembly 100 includes a radio frequency (RF) printed circuit board (PCB) 102 upon which a low-profile connector 104 and an imaging sensor 106 are disposed and electrically connected via conductive traces or wires of the PCB 102. The low-profile connector 104 serves to electrically couple the camera assembly 100 to other electronic components of an electronic device implementing the camera assembly 100 via a cable or other conductive connector.

The imaging sensor 106 comprises a complementary metal oxide semiconductor (CMOS) sensor, charge coupled device (CCD) sensor, or other sensor having a matrix of photoelectric sensors (also referred to as “pixel sensors”) to detect incident light and to output an electrical signal representative of an image captured by the matrix of photoelectric sensors. The imaging sensor 106 is configured to capture both visible light imagery and IR light imagery, either concurrently or as separate image captures. To this end, in some embodiments the same pixel sensors may be used for both IR and visible light capture, with post-capture processing utilized to separate the visual light content and the IR light content. In other embodiments, the imaging sensor employs one set of pixel sensors configured for visible light capture and a separate set of pixels configured for IR light capture. An example of such a configuration using a mosaic of RGB and IR filter elements is described in co-pending U.S. Patent Application Publication No. 2014/0240492.

In some instances, it may be advantageous to filter out certain portions of the visible light spectrum or the IR light spectrum during image capture. Accordingly, in at least one embodiment, the camera assembly 100 may include a dual band pass filter 108 overlying the imaging sensor 106, and which operates to filter out incident light outside of the two pass bands for which the filter 108 is configured. For example, some implementations may seek to filter out the near-infrared (NIR) spectrum (7-10 nm wavelengths) content, and thus the dual band pass filter 108 is configured to filter out electromagnetic radiation in the NIR spectrum while permitting EM radiation in the visible light spectrum and the medium IR (MIR) spectrum and far IR (FIR) spectrum to pass through.

A shielding assembly 110 and lens barrel assembly 112 are mounted over the imaging sensor 106 and the dual band pass filter 108. The shielding assembly 110 comprises a housing that functions to shield the imaging sensor from ambient light, as well as to serve as the mounting structure for the lens barrel assembly 112. The lens barrel assembly 112 comprises a lens barrel 114 extending between a distal surface 116 and a proximal surface 118 of a housing of the lens barrel assembly 112, and which contains a lens assembly (not shown in FIG. 1) comprising a set of one or more optical elements (e.g., lenses) and spacers arranged about an optical axis that is substantially coaxial with the axis of the lens barrel 114. The lens barrel assembly 112 further may include various other features well known in the art, such as a mechanical shutter, a microelectrical-mechanical (MEMS)-based focusing unit, and the like.

In operation, light incident on an aperture 120 of the lens barrel 114 at the distal surface 116 is gathered and focused by the lens assembly onto the imaging sensor 106 through the dual band pass filter 108. The photoelectric sensors of the imaging sensor 106 then convert the incident photons into a corresponding electrical signal, which is output by the camera assembly 100 as raw image data to the processing system of the electronic device implementing the camera assembly 100. The processing system then processes the raw image data to facilitate various functions, including the display of the captured imagery, the detection of the depth of position of objects based on the captured imagery, and the like. As part of this processing, the electronic device may make separate use of both the visible light content and the IR light content that may be captured by the imaging sensor 106. Accordingly, in implementations whereby the imaging sensor 106 employs separate IR light photoelectric sensors and visible light photoelectric sensors, the electronic device may use the imaging sensor 106 to capture both IR imagery and visible light imagery simultaneously. In other embodiments, the electronic device may use the imaging sensor 106 to capture visible light imagery in one captured image and IR light imagery in a separate captured image.

The lower sensitivity of the photoelectric sensors of the imaging sensor 106 to IR light relative to visible light typically necessitates a smaller f-stop (that is, a larger entrance pupil for a given focal length) for IR imagery capture so that more IR light is incident on the imaging sensor; that is, to provide increased illuminance of the imaging sensor 106 by IR light. Conversely, excessive light incident on the imaging sensor 106 during visible light imagery capture can lead to undesirable aberrations, and thus a larger f-stop (that is, a smaller entrance pupil for a given focal length) typically is desired for visible light imagery capture. One conventional approach to achieving one f-stop for IR imagery capture and a different f-stop for visible light image capture is either to maintain the same entrance pupil diameter but increase or decrease the effective focal length by moving one or more optical elements of a lens assembly relative to the imaging sensor along the optical axis, or to change the entrance pupil width via a shutter or other mechanical assembly. However, both of these approaches increase the cost, size, and complexity of a camera assembly due to the mechanical apparatus needed to implement this movement, as well as introduce a potential point of failure due to their mechanical nature. Moreover, these approaches prevent effective capture of both IR light imagery and visible light imagery at the same time.

Rather than employing a cumbersome mechanical assembly to provide different f-stop settings for IR and visible light imagery capture, in at least one embodiment the camera assembly 100 employs a filter 122 that, through selective filtering out of visible light, provides a larger effective entrance pupil (and thus smaller f-stop) for IR light and a smaller effective entrance pupil (and thus larger f-stop) for visible light. Moreover, because the filter 122 provides the dual entrance pupils at the same time, the imaging sensor 106 may be used to capture both IR light imagery and visible light imagery concurrently, and with each type of imagery being captured with a suitable corresponding f-stop.

The filter 122 is arranged so as to be substantially coaxial with the optical axis of the lens barrel assembly 112, and may be placed at any position along the optical axis within the lens barrel assembly 112. To illustrate, in the embodiment depicted in FIGS. 1 and 2, the filter 122 is disposed in or at the distal aperture 120 of the lens barrel assembly 112. However, in other embodiments, the filter 122 may be disposed in or at a proximal aperture (not shown) at the proximal surface 118 of the lens barrel assembly 112, in between two optical elements of the lens assembly, and the like.

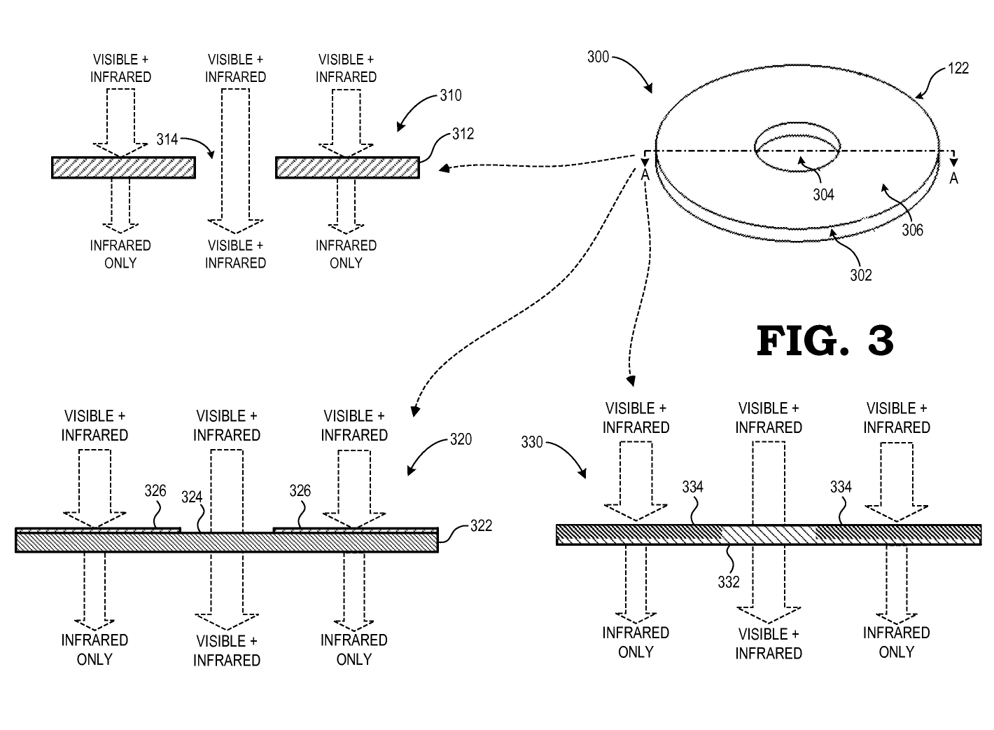

FIG. 3 illustrates various example implementations of the filter 122 in accordance with embodiments of the present disclosure. As depicted by the perspective view 300, the filter 122 comprises a planar member 302 that defines a center region 304 positioned at a center of the planar member 302 and a perimeter region 306 encircling or otherwise surrounding the center region 304. In some embodiments, the planar member 302 is positioned substantially perpendicular to the optical axis. In the illustrated example, the filter 122 is substantially circular (i.e., a thin cylinder) and the center region 304 is substantially circular, and the perimeter region 306 forms a substantially circular ring around the center region 304. In other embodiments, one or more of the planar member 302, the center region 304, or the perimeter region 306 may have a different shape. For example, the planar member 302 may have a rectangular shape, the center region 304 may have a circular shape, and the perimeter region 306 defines the space between the perimeter of the center region and the edges of the planar member 302.

In at least one embodiment, the center region 304 is configured so as to be transparent to both visible light and IR light (that is, to pass substantially all IR light and visible light incident on the center region), whereas the perimeter region 306 is configured so as to be transparent to IR light (that is, to pass substantially all incident IR light) but opaque to visible light (that is, to reject transmission of substantially all incident visible light). As such, the center region 304 acts as a “through-hole” for visible light, whereas the perimeter region 306 blocks visible light. As such, the filter 122 is also referred to herein as “through-hole filter 122”, where “through-hole” may refer to a literal or figurative “hole” through the filter 122 with respect to transmission of visible light.

This configuration of selective visible light transmittance may be achieved in any of a variety of ways. As one example, cross-section view 310 (along cut line A-A) illustrates one implementation of the through-hole filter 122 in a form similar to an O-ring, whereby the planar member 302 is in the form of a ring 312 having a through-hole 314 or other void in the center, whereby the through-hole 314 defines the center region 304 and the ring 312 defines the perimeter region 306. The through-hole 314, being substantially devoid of material, is transparent to both visible light and IR light. The ring 312 is composed of a material that selectively transmits IR light while blocking visible light and thus is transparent to IR light and opaque to visible light. As a result, when installed in the camera assembly 100, the diameter of the through-hole 314 represents the effective diameter of the entrance pupil or aperture for purposes of visible light capture, whereas the greater diameter of the ring 312 represents the effective diameter of the entrance pupil or aperture for purposes of IR light capture.

The ring 312 may be composed of any of a variety of materials known for their selective IR transmissivity, or combinations of such materials. Examples of such materials include, but are not limited to, Germanium (Ge), Silicon (Si), Gallium Arsenide (GaAs), Cadmium Telluride (CdTe), Schott IG2, AMTIR-1, GASIR-1, and Infrared plastic. In some embodiments, the ring 312 may be composed of a monolithic block of material, such as a ring formed from a block of germanium or silicon. In other embodiments, the ring 312 may be composed of a substrate formed in the shape of a ring and then coated or embedded with an IR light transparent/visible light opaque material.

Rather than using a literal through-hole devoid of material to pass both IR and visible light, in other embodiments the planar member 302 of the through-hole filter 122 may be formed from a substrate that is transparent to both IR light and visible light, and then the portion of the substrate defining the perimeter region 306 may be coated or embedded with IR transparent/visible light opaque material, and thus forming a figurative “through-hole” in the center region 304 for transmission of visible light. To illustrate, cross-section view 320 depicts an implementation of the through-hole filter 122 whereby the planar member 302 is formed as a substrate 322 transparent to both IR light and visible light, and upon a surface 324 of which a coating 326 of IR light transparent/visible light opaque material is deposited in areas defining the perimeter region 306, while the area defining the center region 304 is substantially devoid of this material. Similarly, cross-section view 330 depicts an implementation of the through-hole filter 122 whereby the planar member 302 is formed as a substrate 332 transparent to both IR light and visible light and in which IR transparent/visible light opaque material 344 is implanted or otherwise embedded in the area defined by the perimeter region 306 while the area of the substrate 332 defining center region 304 is substantially devoid of this material. In either implementation, the area of the substrate 322/332 in the center region 304 is devoid of visible light opaque material, and thus the center region 304 of the substrate passes both visible light and IR light. However, the IR transparent/visible light opaque material in or on the surrounding region of the substrate 322/332 prevents visible light transmittance, and thus limits the visible light transmission to only the center region 304.

The substrate 322/332 may be formed from any of a variety of materials transparent to both visible light and IR light. Examples of such materials include, but are not limited to, fused silica (Si0₂), sodium chloride (NaCl), potassium bromide (KBr), Potassium Chloride (KCl), and for NIR and MIR implementations, sapphire (Al₂O₃). Examples of the IR light transparent/visible light opaque material that may be implanted in, or coated on, the substrate 322/332 include, but are not limited to, Germanium (Ge), Silicon (Si), Gallium Arsenide (GaAs), Cadmium Telluride (CdTe), Schott IG2, Scott IG6, GASIR-1, Zinc Selenide (ZnSe), and Thallium Bromoidide (KRS-5), or combinations thereof.

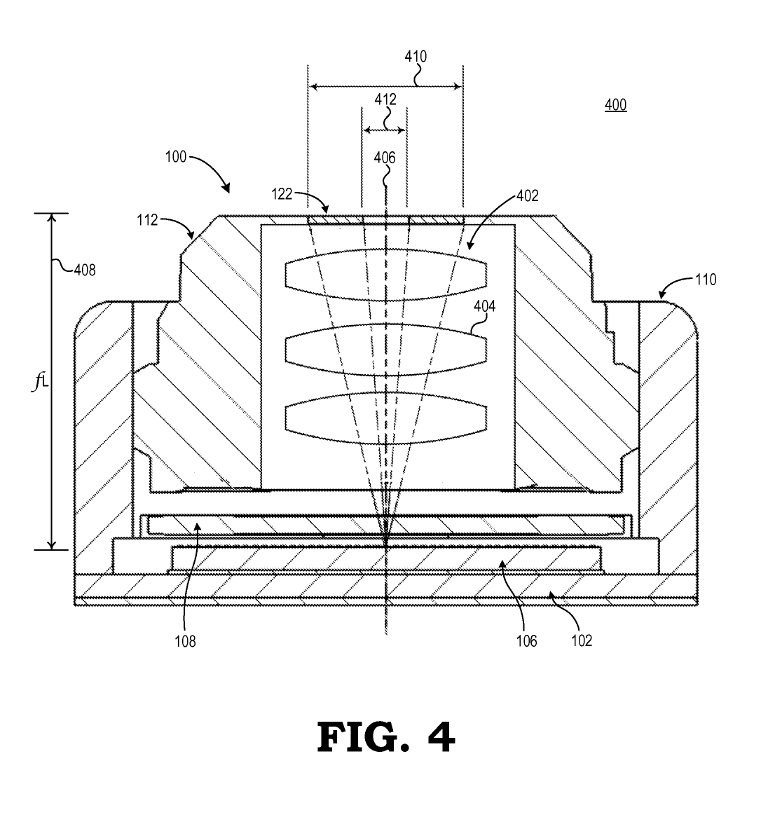

FIG. 4 illustrates a cross-section view of the camera assembly 100 of FIGS. 1 and 2 in accordance with at least one embodiment of the present disclosure. As shown, the camera assembly 100 may be assembled by: mounting the imaging sensor 106 to the PCB 102; assembling a lens assembly 402 comprising one or more optical elements 404 arranged about an optical axis 406 and inserting the lens assembly 402 into the lens barrel 114 of the lens barrel assembly 112. The lens barrel assembly 112 then may be attached at the distal end of the shielding assembly 110 via any of a variety of fastening means, including threads, adhesive, bolts, pins, and the like. The dual band pass filter 108 then may be attached to the proximal end of the shielding assembly 110 (or positioned overlying the imaging sensor 106), and the resulting assembly may be positioned over the imaging sensor 106 and then fastened to the PCB 102 using any of a variety of fastening mechanisms. At some point during the assembly process, such as during assembly of the lens barrel assembly 112, the through-hole filter 122 is affixed in the distal aperture 120 of the lens barrel assembly 112, or in some other position substantially coaxial with the optical axis 406 of the lens assembly 402, such as between one or more of the optical elements 404 of the lens assembly 402, or between the last optical element 404 and the dual band pass filter 108.

With the through-hole filter 122 positioned about the optical axis 406 in this manner, the through-hole filter 122 presents two different entrance pupils for the same focal length 408: an entrance pupil having an effective diameter 410 for transmittance of IR light, and an entrance pupil having a smaller effective diameter 412 for transmittance of visible light. Thus, as described above, the through-hole filter 122 permits the implementation of a different f-stop for capturing IR imagery than the f-stop used for capturing visible light imagery, but does not require mechanical adjustment of the camera assembly 100 and thus permits both IR imagery and visible light imagery to be captured concurrently with suitable f-stop configurations for each type of image capture.

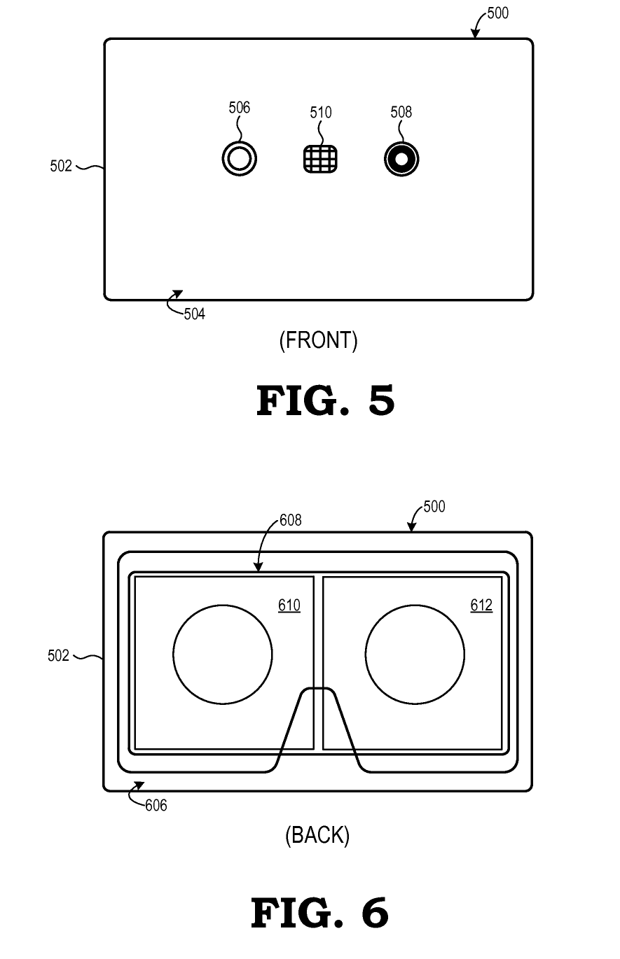

FIGS. 5 and 6 illustrate front and back views, respectively, of a portable electronic device 500 implementing the camera assembly 100 in accordance with at least one embodiment of the present disclosure. The portable electronic device 500 can include any of a variety of devices, such as head mounted display (HMD), a tablet computer, computing-enabled cellular phone (e.g., a “smartphone”), a notebook computer, a personal digital assistant (PDA), a gaming console system, and the like. For ease of illustration, the portable electronic device 500 is generally described herein in the example context of an HMD system; however, the portable electronic device 500 is not limited to an HMD implementation.

In the depicted example, the portable electronic device 500 includes a housing 502 having a surface 504 (FIG. 5) opposite another surface 606 (FIG. 6), as well as a set of straps or a harness (omitted from FIGS. 5 and 6 for clarity) to mount the housing 502 on the head of a user so that the user faces the surface 606 of the housing 502. In the example thin rectangular block form-factor depicted, the surfaces 504 and 606 are substantially parallel and the housing 502. The housing 502 may be implemented in many other form factors, and the surfaces 504 and 606 may have a non-parallel orientation. For the illustrated HMD system implementation, the portable electronic device 500 includes a display device 608 disposed at the surface 606 for presenting visual information to the user.

The portable electronic device 500 also includes a plurality of sensors to obtain information regarding a local environment. The portable electronic device 500 obtains visual information (imagery) for the local environment via one or more camera assemblies, such as camera assemblies, such as camera assemblies 506, 508 (FIG. 5) disposed at the forward-facing surface 504. One or both of these camera assemblies may represent an embodiment of the camera assembly 100 and thus be configured with a through-hole filter 122 as described above.

The camera assemblies 506, 508 can be positioned and oriented on the forward-facing surface 504 such that their fields of view overlap starting at a specified distance from the portable electronic device 500, thereby enabling depth sensing of objects in the local environment that are positioned in the region of overlapping fields of view via multiview image analysis. Alternatively, a depth sensor 510 (FIG. 5) disposed at the surface 504 may be used to provide depth information for the objects in the local environment. The depth sensor 510, in one embodiment, is a structured light projector to project structured IR light patterns from the forward-facing surface 504 into the local environment, and which uses one or both of camera assemblies 506, 508 to capture reflections of the IR light patterns as they reflect back from objects in the local environment. These structured IR light patterns can be either spatially-modulated light patterns or temporally-modulated light patterns. The captured reflections of a modulated light flash are referred to herein as “depth images” or “depth imagery.” The depth sensor 510 then may calculate the depths of the objects, that is, the distances of the objects from the portable electronic device 500, based on the analysis of the depth imagery. The resulting depth data obtained from the depth sensor 510 may be used to calibrate or otherwise augment depth information obtained from multiview analysis (e.g., stereoscopic analysis) of the image data captured by the camera assemblies 506, 508. Alternatively, the depth data from the depth sensor 510 may be used in place of depth information obtained from multiview analysis.

One or more of the camera assemblies 506, 508 may serve other imaging functions for the portable electronic device 500 in addition to capturing imagery of the local environment. To illustrate, the camera assemblies 506, 508 may be used to support visual telemetry functionality, such as capturing imagery to support position and orientation detection. The portable electronic device 500 also may rely on non-image information for position/orientation detection. This non-image information can be obtained by the portable electronic device 500 via one or more non-imaging sensors (not shown), such as a gyroscope or ambient light sensor. The non-imaging sensors also can include user interface components, such as a keypad (e.g., touchscreen or keyboard), microphone, mouse, and the like.

In operation, the portable electronic device 500 captures imagery of the local environment via one or both of the camera assemblies 506, 508, modifies or otherwise processes the captured imagery, and provides the processed captured imagery for display on a display device 608 (FIG. 6). The processing of the captured imagery can include, for example, spatial or chromatic filtering, addition of an AR overlay, conversion of the real-life content of the imagery to corresponding VR content, and the like. As shown in FIG. 6, in implementations with two imaging sensors, the imagery from the left side camera assembly 508 may be processed and displayed in a left side region 610 of the display device 608 concurrent with the processing and display of the imagery from the right side camera assembly 506 in a right side region 612 of the display device 608, thereby enabling a stereoscopic 3D display of the captured imagery.

In addition to capturing imagery of the local environment for display with AR or VR modification, in at least one embodiment the portable electronic device 500 uses the imaging data and the non-imaging sensor data to determine a relative position/orientation of the portable electronic device 500, that is, a position/orientation relative to the local environment. This relative position/orientation information may be used by the portable electronic device 500 in support of simultaneous location and mapping (SLAM) functionality, visual odometry, or other location-based functionality. Further, the relative position/orientation information may support the generation of AR overlay information that is displayed in conjunction with the captured imagery, or in the generation of VR visual information that is displayed in representation of the captured imagery. As an example, the portable electronic device 500 can map the local environment and then use this mapping to facilitate the user's navigation through the local environment, such as by displaying to the user a floor plan generated from the mapping information and an indicator of the user's current location relative to the floor plan as determined from the current relative position of the portable electronic device 500.

To this end, the determination of the relative position/orientation may be based on the detection of spatial features in image data captured by one or more of the camera assemblies 506, 508 and the determination of the position/orientation of the portable electronic device 500 relative to the detected spatial features. From visible light imagery or IR light imagery captured by the camera assemblies 506, 508, the portable electronic device 500 can determine its relative position/orientation without explicit absolute localization information from an external source. To illustrate, the portable electronic device 500 can perform multiview analysis of visible light imagery captured by each of the camera assemblies 506, 508 to determine the distances between the portable electronic device 500 and various features in the local environment. Alternatively, depth data obtained from the depth sensor 510 can be used to determine the distances of the spatial features. From these distances the portable electronic device 500 can triangulate or otherwise infer its relative position in the local environment. As another example, the portable electronic device 500 can identify spatial features present in one set of captured visible light image frames, determine the initial distances to these spatial features based on depth data extracted from IR light image frame, and then track the changes in position and distances of these spatial features in subsequent captured imagery to determine the change in position/orientation of the portable electronic device 500. In this approach, certain non-imaging sensor data, such as gyroscopic data or accelerometer data, can be used to correlate spatial features observed in one image frame with spatial features observed in a subsequent image frame. Moreover, the relative position/orientation information obtained by the portable electronic device 500 can be combined with supplemental information to present an AR view or VR view of the local environment to the user via the display device 608 of the portable electronic device 500. This supplemental information can include one or more databases locally stored at the portable electronic device 500 or remotely accessible by the portable electronic device 500 via a wired or wireless network.

In accordance with one aspect of the present disclosure, a camera filter includes a center region transparent to visible light and infrared light and a perimeter region substantially surrounding the center region, the perimeter region transparent to infrared light and opaque to visible light. The camera filter may be implemented as a planar member defining the center region and the perimeter region, wherein the center region is a through-hole in the planar member. The camera filter may be implemented as a substrate defining the center region and the perimeter region, the substrate being transparent to visible light and infrared light, and further implemented with a material disposed in the perimeter region and substantially absent from the center region, the material transparent to infrared light and opaque to visible light.

In accordance with another aspect of the present disclosure, a camera assembly includes a lens barrel assembly comprising at least one optical element arranged about an optical axis. The camera assembly further includes a filter substantially coaxial with the optical axis, the filter presenting a first aperture having a first width for transmission of infrared light and a second aperture having a second width for transmission of visible light, the second width less than the first width.

In accordance with yet another aspect of the present disclosure, an electronic device includes a structured light projector to project infrared light and a camera assembly to capture infrared light and visible light incident on an aperture of the camera assembly. The camera assembly includes a filter arranged substantially coaxial with the aperture. The filter to provide an entrance pupil having a first effective width for infrared light and an entrance pupil having a second effective width for visible light, the second effective width less than the first effective width. The camera assembly further includes an imaging sensor to capture imagery based on the infrared light and visible light transmitted through the filter.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A camera filter comprising:
a center region transparent to visible light and infrared light; and
a perimeter region substantially surrounding the center region, the perimeter region transparent to infrared light and opaque to visible light.

2. The camera filter of claim 1, further comprising:
a planar member defining the center region and the perimeter region; and
wherein the center region is a through-hole in the planar member.

3. The camera filter of claim 1, further comprising:
a substrate defining the center region and the perimeter region, the substrate being transparent to visible light and infrared light; and
a material disposed in the perimeter region and substantially absent from the center region, the material transparent to infrared light and opaque to visible light.

4. The camera filter of claim 3, wherein the material is disposed at a surface of the substrate.

5. The camera filter of claim 3, wherein the material is embedded within the substrate.

6. A camera assembly comprising the camera filter of claim 1.

7. A portable electronic device comprising the camera assembly of claim 6.

8. A camera assembly comprising:
a lens barrel assembly comprising at least one optical element arranged about an optical axis; and
a filter substantially coaxial with the optical axis, the filter presenting a first aperture having a first width for transmission of infrared light and a second aperture having a second width for transmission of visible light, the second width less than the first width.

9. The camera assembly of claim 8, wherein:
the filter comprises a planar member substantially perpendicular to the optical axis, the planar member comprising:
a center region substantially coaxial with the optical axis, the center region being transparent to both visible light and infrared light; and
a perimeter region surrounding the center region, the perimeter region being transparent to infrared light and opaque to visible light.

10. The camera assembly of claim 9, wherein:
the planar member is composed of a material opaque to visible light and transparent to infrared light; and
the center region is a void in the material of the planar member.

11. The camera assembly of claim 10, wherein the material is composed of at least one of: germanium (Ge), silicon (Si), gallium arsenide (GaAs), cadmium telluride (CdTe), and infrared plastic.

12. The camera assembly of claim 9, wherein:
the planar member comprises:
a substrate transparent to both visible light and infrared light; and
material disposed at the substrate in a region defining the perimeter region, wherein the material is transparent to infrared light and opaque to visible light; and
wherein the region of the substrate defining the center region is substantially devoid of the material.

13. The camera assembly of claim 8, wherein:
the lens barrel assembly comprises an aperture substantially coaxial with the optical axis; and
the filter is disposed at the aperture.

14. The camera assembly of claim 13, wherein the aperture is at a distal surface of the lens barrel assembly.

15. The camera assembly of claim 13, wherein the aperture is internal to the lens barrel assembly.

16. The camera assembly of claim 8, further comprising:
an imaging sensor disposed at one end of the lens barrel assembly and substantially coaxial with the optical axis.

17. The camera assembly of claim 16, wherein the imaging sensor comprises:
a set of pixel sensors to capture visible light; and
a set of pixel sensors to capture infrared light.

18. The camera assembly of claim 16, further comprising:
a dual band pass filter disposed between the at least one optical element and the imaging sensor.

19. A portable electronic device comprising the camera assembly of claim 8.

20. An electronic device comprising:
a structured light projector to project infrared light; and
a camera assembly to capture infrared light and visible light incident on an aperture of the camera assembly, the camera assembly comprising:
a filter arranged substantially coaxial with the aperture, the filter to provide an entrance pupil having a first effective width for infrared light and an entrance pupil having a second effective width for visible light, the second effective width less than the first effective width; and
an imaging sensor to capture imagery based on the infrared light and visible light transmitted through the filter.

21. The electronic device of claim 20, wherein the filter comprises:
a center region transparent to visible light and infrared light; and
a perimeter region substantially surrounding the center region and transparent to infrared light and opaque to visible light.

22. The electronic device of claim 21, wherein:
the perimeter region comprises material transparent to infrared light and opaque to visible light; and
the center region is devoid of the material.
